(19) United States
(12) Patent Application Publication
(10) Pub. No.: US 2026/0054552 A1
(43) Pub. Date: Feb. 26, 2026

(54) ASSIST VIEWING SYSTEM

(71) Applicant: GM GLOBAL TECHNOLOGY OPERATIONS LLC, DETROIT, MI (US)

(72) Inventors: Jiwoong Kim, Seoul (KR); Shin Han, Gimpo (KR); Seunghee Choi, Seoul (KR)

(21) Appl. No.: 18/812,433

(22) Filed: Aug. 22, 2024

(51) Int. Cl. B60J 3/02; B60J 3/00; B60J 3/04; G02F 1/137

(52) U.S. Cl. CPC B60J 3/0243; B60J 3/007; B60J 3/04; G02F 1/13756

(57) ABSTRACT

A sunshade assembly of a vehicle includes a sunshade including a frame, and a polymer-dispersed liquid crystal (PDLC) film secured in a frame. A drive apparatus is operably connected to the sunshade to urge the sunshade between a retracted position between a roof panel and a headliner of the vehicle and an extended position protruding from the headliner. A method of operating a sunshade of a vehicle includes determining a level of sunlight glare on an operator of the vehicle and comparing the level of sunlight glare to a predetermined threshold. A sunshade, including a PDLC film, is moved between a retracted position between a headliner and a roof panel of the vehicle and an extended position partially across a windshield of the vehicle. The PDLC film is selectably energized to change the opacity of the PDLC film in response to the determined level of sunlight glare.

The subject disclosure relates to vehicles, and in particular to viewing assist systems, such as sunshades, of vehicles.

Changing light conditions while operating a vehicle can cause strong sunlight light conditions or glare in the operator's field of view at the windshield. A vehicle typically includes a sun visor at the driver's location, which the operator manually rotates downwardly in order to block sunlight or glare that is affecting their visibility through the windshield.

It is desired to improve performance of sun visor devices and improve visibility for vehicle operators during changing light conditions.

### SUMMARY

In one exemplary embodiment, a sunshade assembly of a vehicle includes a sunshade including a frame, and a polymer-dispersed liquid crystal (PDLC) film secured in a frame. A drive apparatus is operably connected to the sunshade to urge the sunshade between a retracted position between a roof panel and a headliner of the vehicle and an extended position protruding from the headliner.

In addition to one or more of the features described herein the PDLC film is selectably switchable between a transparent state and an opaque state.

In addition to one or more of the features described herein a controller is configured to signal the drive apparatus to move the sunshade between the retracted position and the extended position.

In addition to one or more of the features described herein the extended position is calculated from one or more of a GPS location of the vehicle, a compass reading, a time and date, and a light level received from a sunlight sensor.

In addition to one or more of the features described herein the drive apparatus includes an electric motor operably connected to the frame.

In addition to one or more of the features described herein the drive apparatus includes one or more gears operably connected to one or more drive features of the frame, and rotation of the one or more gears drives movement of the sunshade between the retracted position and the extended position.

In addition to one or more of the features described herein one or more guide rails are interactive with the frame to guide movement of the sunshade.

In another exemplary embodiment, a vehicle includes a vehicle body, a windshield installed to the vehicle body, and a sunshade assembly. The sunshade assembly includes a sunshade including a frame and a polymer-dispersed liquid crystal (PDLC) film secured in a frame. A drive apparatus is operably connected to the sunshade to urge the sunshade between a retracted position between a roof panel of the vehicle body and a headliner of the vehicle and an extended position protruding from the headliner at least partially across the windshield.

In addition to one or more of the features described herein the PDLC film is selectably switchable between a transparent state and an opaque state.

In addition to one or more of the features described herein a controller is configured to signal the drive apparatus to move the sunshade between the retracted position and the extended position.

In addition to one or more of the features described herein the extended position is calculated from one or more of a GPS location of the vehicle, a compass reading, a time and date, and a light level received from a sunlight sensor.

In addition to one or more of the features described herein the drive apparatus includes an electric motor operably connected to the frame.

In addition to one or more of the features described herein the drive apparatus includes one or more gears operably connected to one or more drive features of the frame, and rotation of the one or more gears drives movement of the sunshade between the retracted position and the extended position.

In addition to one or more of the features described herein one or more guide rails are interactive with the frame to guide movement of the sunshade.

In yet another exemplary embodiment, a method of operating a sunshade of a vehicle includes determining a level of sunlight glare on an operator of the vehicle and comparing the level of sunlight glare to a predetermined threshold. A sunshade is moved between a retracted position between a headliner and a roof panel of the vehicle and an extended position partially across a windshield of the vehicle. The sunshade includes a polymer-dispersed liquid crystal (PDLC) film. The PDLC film is selectably energized to change the opacity of the PDLC film in response to the determined level of sunlight glare.

In addition to one or more of the features described herein the level of sunlight glare is determined via one or more of a GPS location of the vehicle, a compass reading, a time and date, and a light level received from a sunlight sensor.

In addition to one or more of the features described herein the GPS information is utilized to calculate the altitude of the sun by recognizing its location, orientation, date and time.

In addition to one or more of the features described herein the extended position is above an eye level of the operator.

In addition to one or more of the features described herein the sunshade is moved between the retracted position and the extended position via a drive apparatus including an electric motor.

In addition to one or more of the features described herein one or more guide rails are interactive with the sunshade to guide movement of the sunshade between the retracted position and the extended position.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a schematic illustration of an embodiment of a vehicle;

FIG. 2 is a partial cross-sectional view of an embodiment of a passenger compartment of a vehicle;

FIG. 3 is a cross-sectional view of an embodiment of a sunshade assembly of a vehicle;

FIG. 4 is a first perspective view of an embodiment of a sunshade assembly of a vehicle;

FIG. 5 is a third perspective view of an embodiment of a sunshade assembly of a vehicle;

FIG. 6 is a cross-sectional view illustrating a frame engagement to a guide rail of a sunshade assembly; and

FIG. 7 is an illustration of an embodiment of a method of operating a sunshade assembly.

### DETAILED DESCRIPTION

The following description is merely exemplary in nature and is not intended to limit the present disclosure, its application or uses. It should be understood that throughout the drawings, corresponding reference numerals indicate like or corresponding parts and features.

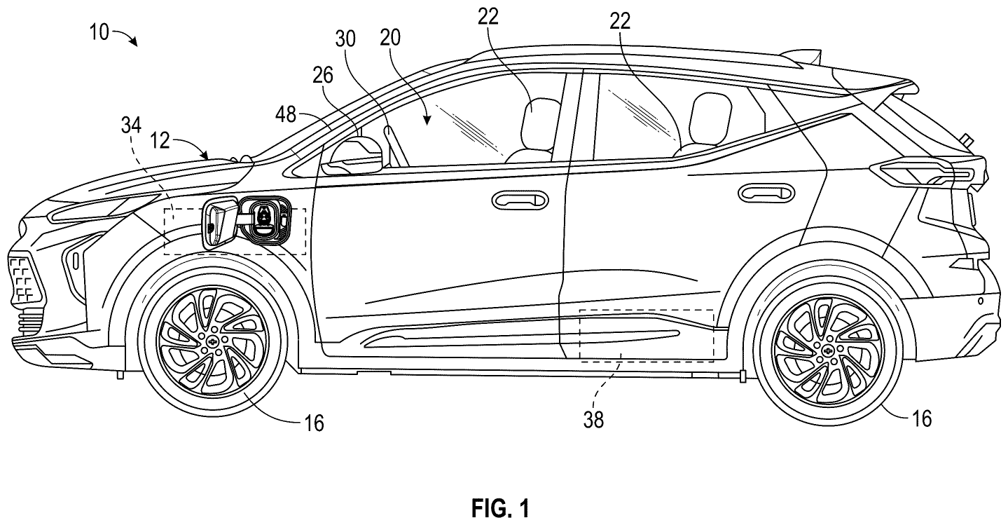

In accordance with an exemplary embodiment a vehicle, in accordance with a non-limiting example, is indicated generally at 10 in FIG. 1. Vehicle 10 includes a body 12 supported on a plurality of wheels 16. In a non-limiting example, two of the plurality of wheels 16 are steerable. Body 12 defines, in part, a passenger compartment 20 having seats 22 positioned behind a dashboard 26. A steering control 30 is arranged between seats 22 and dashboard 26. Steering control 30 is operated to control orientation of the steerable wheel(s). Vehicle 10 includes an electric motor 34 connected to a transmission that provides power to one or more of the plurality of wheels 16. In some embodiments, a rechargeable energy storage system (RESS) assembly 38 provides power to the electric motor 34.

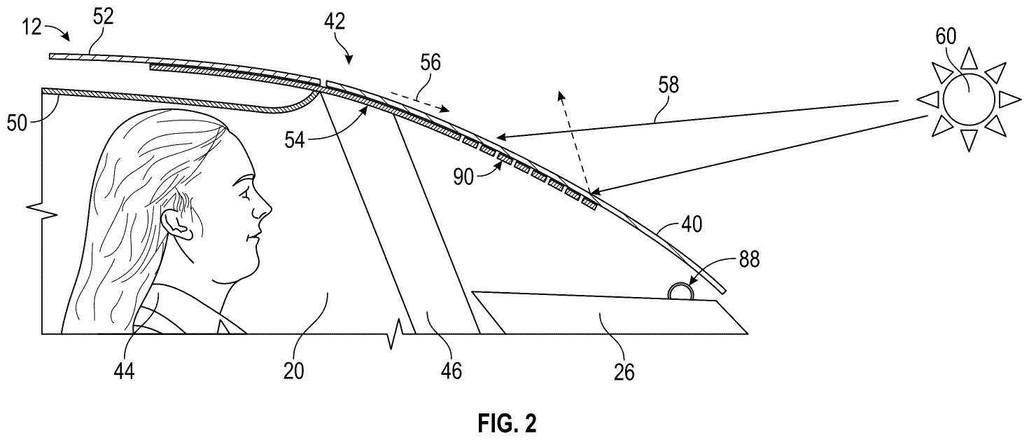

Referring now to FIG. 2, illustrated is a partial cross-sectional view of an embodiment of a passenger compartment 20. A windshield 40 is located in a windshield opening 42 of the body 12, and an operator 44 of the vehicle 10 is seated behind the dashboard 26 and looks out of the vehicle 10 through the windshield 40 during operation of the vehicle 10. The passenger compartment 20 may further include one or more pieces of interior trim, including for example, an A-pillar trim 46 affixed to an A-pillar 48 (shown in FIG. 1) of the body 12. Additionally, a headliner 50 may be installed at a roof 52 of the body 12, defining an upper extent of the passenger compartment 20. A movable sunshade 54 is positioned between the headliner 50 and the roof 52, and is configured to selectably move from a retracted position not protruding from the headliner 50, to an extended position, as shown in FIG. 2, at least partially across an upper portion 56 of the windshield 40. In the extended position, the sunshade 54 blocks external light 58 from, for example, the sun 60 in order to reduce light annoyance of the operator 44 and improve visibility while operating the vehicle 10. In some embodiments, the sunshade 54 is formed from a polymer-dispersed liquid crystal (PDLC) material. When an electric current is applied to the sunshade, the PDLC material turns from opaque or light blocking, to transparent.

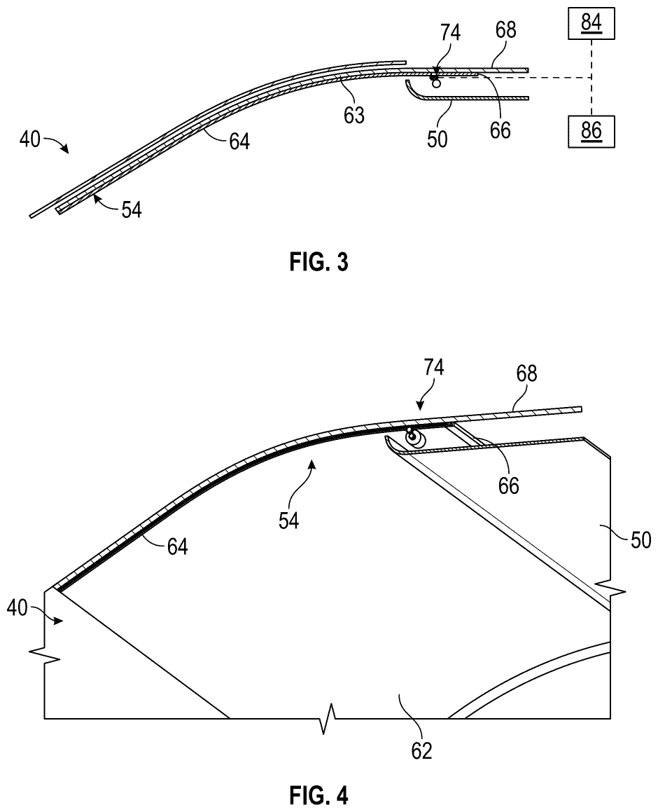

Referring now to FIG. 3, the sunshade 54 includes a PDLC film 62 (shown in FIG. 4) positioned in a frame 63 including side rails 64 extending along lateral sides of the PDLC film 62, and an end rail 66 extending laterally across the PDLC film 62. The side rails 64 and the end rail 66 aid in maintaining position and shape of the PDLC film 62.

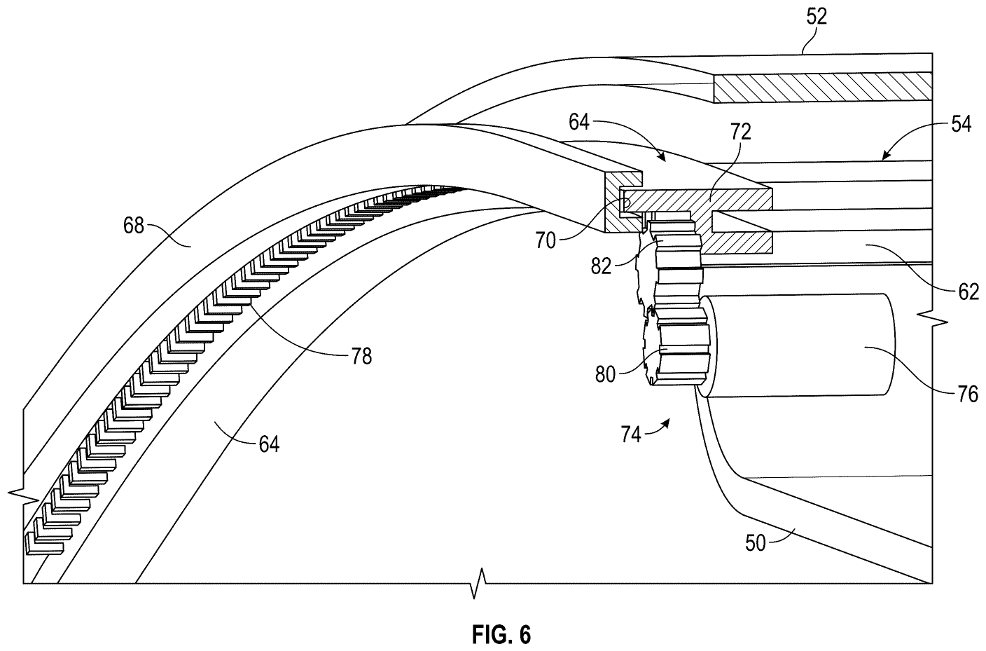

Referring now to FIG. 4, one or more guide rails 68 are secured to the body 12, and are operably connected to a corresponding side rail 64 to guide movement of the sunshade 54. In one embodiment, illustrated in the cross-sectional view of FIG. 6, the guide rail 68 has a rail recess 70 extending along its length into which a complimentary rail rib 72 of the corresponding side rail 64 is installed. This interaction is used to guide travel of the sunshade 54 between the retracted position and the extended position.

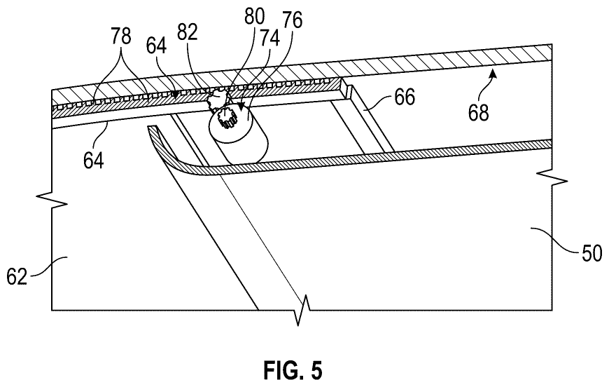

Referring now to FIG. 5, a drive apparatus 74 is operably connected to the sunshade 54 to drive and control the movement of the sunshade 54 along the guide rail 68. In some embodiments, the drive apparatus 74 is positioned between the headliner 50 and the roof 52 and includes an electric motor 76 operably connected to at least one of the side rails 64. In the embodiment illustrated herein, the side rail 64 includes a plurality of drive pins 78 protruding therefrom, and the electric motor 76 includes an output gear 80. The output gear 80 is meshed with a transfer gear 82, which in turn is meshed with the plurality of drive pins 78. Thus operation of the electric motor 76 transfers rotational energy through the output gear 80, the transfer gear 82 and to the plurality of drive pins 78, where the rotational energy is transformed into linear motion to move the sunshade 54 along the guide rail 68. It is to be appreciated that the drive apparatus 74 illustrated and described herein is merely exemplary and other types of drive mechanisms may be utilized within the scope of the present disclosure. As illustrated in FIG. 3, the drive apparatus 74 is operably connected to a power source 84 and is connected to a controller 86 to control operation of the drive apparatus 74 and thus the movement of the sunshade 54. Additionally, the power source 84 and the controller 86 may further be connected to the PDLC film 62 to selectably apply current to the PDLC film 62 thus controlling the opacity of the PDLC film 62.

In some embodiments, the sunshade 54 may be operable in an automatic mode, utilizing a sunlight sensor 88 as shown in FIG. 2, operably connected to the controller 86, which may also use other data inputs such as compass information, global positioning system (GPS) information, and/or time of day information to adjust the position of the sunshade 54 to reduce the glare experienced by the operator 44.

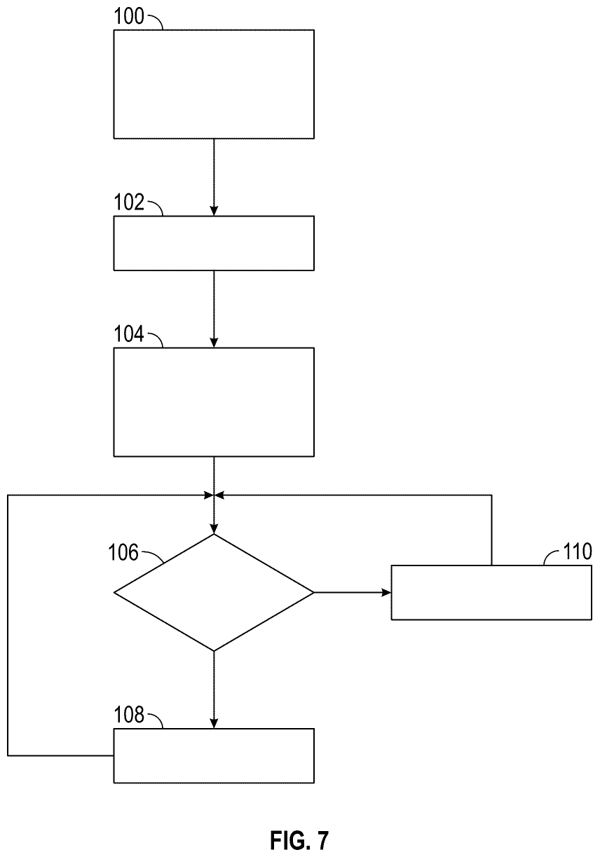

A method of operating the sunshade 54 is illustrated in FIG. 7. At step 100, a determination is made whether it is daytime using, for example, the sunlight sensor 88 and/or a clock. If it is determined to be daytime, vehicle sensors such as the sunlight sensor 88, GPS, compass, date and time information, are utilized to monitor potential sun glare to the operator 44 at step 102. More particularly, in some embodiments, the controller 86 utilizes GPS information to calculate the altitude (solar elevation/azimuth angle) of the sun by recognizing its location, orientation, date and time. Given the altitude information, at step 104 the controller 86 calculates and drives the sunshade 54 to a calculated sunshade length 90 shown in FIG. 2 protruding from the headliner 50. The sunshade length 90 is set to be above an eye level of the operator 44 to prevent obstructing of vision. In some embodiments, the sunshade length 90 is calculated as:

$$sunshade length = ( distance operator sunshade ) * ( 90 ° - solar elevation angle ) * 2 π / 360 ° ) + / - α .$$

In the above equation, α represents a measure of the operator's seat height. The amount of change in the sunshade length due to the operator's seat height may be adjusted via the controller 86.

Once the sunshade length 90 is set, the sunlight sensor 88 is utilized to continuously monitor the sunlight level. If the detected sunlight exceeds a threshold at step 106, the PDLC film 62 is energized by the controller 86 to turn the PDLC film 62 to a non-transparent state at step 108. If the threshold is not exceeded, the PDLC film 62 is deenergized to a transparent state at step 110. The transparent state of the PDLC film 62 is, in some embodiments, 85%.

The sunshade 54 reduces sun glare annoyance experienced by the operator 44 even in variable light conditions, and in some embodiments is configured for automatic operation in response to detected light levels and sun position.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on”another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A sunshade assembly of a vehicle, comprising:
a sunshade including:
a frame; and
a polymer-dispersed liquid crystal (PDLC) film secured in a frame; and
a drive apparatus operably connected to the sunshade to urge the sunshade between a retracted position between a roof panel and a headliner of the vehicle and an extended position protruding from the headliner.

2. The sunshade assembly of claim 1, wherein the PDLC film is selectably switchable between a transparent state and an opaque state.

3. The sunshade assembly of claim 1, further comprising a controller configured to signal the drive apparatus to move the sunshade between the retracted position and the extended position.

4. The sunshade assembly of claim 1, wherein the extended position is calculated from one or more of a GPS location of the vehicle, a compass reading, a time and date, and a light level received from a sunlight sensor.

5. The sunshade assembly of claim 1, wherein the drive apparatus includes an electric motor operably connected to the frame.

6. The sunshade assembly of claim 1, wherein the drive apparatus includes one or more gears operably connected to one or more drive features of the frame, and rotation of the one or more gears drives movement of the sunshade between the retracted position and the extended position.

7. The sunshade assembly of claim 1, further comprising one or more guide rails interactive with the frame to guide movement of the sunshade.

8. A vehicle, comprising:
a vehicle body;
a windshield installed to the vehicle body; and
a sunshade assembly including:
a sunshade including:
a frame; and
a polymer-dispersed liquid crystal (PDLC) film secured in a frame; and
a drive apparatus operably connected to the sunshade to urge the sunshade between a retracted position between a roof panel of the vehicle body and a headliner of the vehicle and an extended position protruding from the headliner at least partially across the windshield.

9. The vehicle of claim 8, wherein the PDLC film is selectably switchable between a transparent state and an opaque state.

10. The vehicle of claim 8, further comprising a controller configured to signal the drive apparatus to move the sunshade between the retracted position and the extended position.

11. The vehicle of claim 8, wherein the extended position is calculated from one or more of a GPS location of the vehicle, a compass reading, a time and date, and a light level received from a sunlight sensor.

12. The vehicle of claim 8, wherein the drive apparatus includes an electric motor operably connected to the frame.

13. The vehicle of claim 8, wherein the drive apparatus includes one or more gears operably connected to one or more drive features of the frame, and rotation of the one or more gears drives movement of the sunshade between the retracted position and the extended position.

14. The vehicle of claim 8, further comprising one or more guide rails interactive with the frame to guide movement of the sunshade.

15. A method of operating a sunshade of a vehicle, comprising:
determining a level of sunlight glare on an operator of the vehicle;
comparing the level of sunlight glare to a predetermined threshold;
moving a sunshade between a retracted position between a headliner and a roof panel of the vehicle and an extended position partially across a windshield of the vehicle, the sunshade including a polymer-dispersed liquid crystal (PDLC) film; and
selectably energizing the PDLC film to change an opacity of the PDLC film in response to the determined level of sunlight glare.

16. The method of claim 15, further comprising determining the level of sunlight glare via one or more of a GPS location of the vehicle, a compass reading, a time and date, and a light level received from a sunlight sensor.

17. The method of claim 16, further comprising utilizing the GPS location to calculate an angle of the sun by recognizing its location, orientation, date and time.

18. The method of claim 15, wherein the extended position is above an eye level of the operator.

19. The method of claim 15, further comprising moving the sunshade between the retracted position and the extended position via a drive apparatus including an electric motor.

20. The method of claim 15, further comprising one or more guide rails interactive with the sunshade to guide movement of the sunshade between the retracted position and the extended position.
